(19) United States
(12) Patent Application Publication
(10) Pub. No.: US 2025/0326397 A1
(43) Pub. Date: Oct. 23, 2025

(54) VEHICLE CONTROL APPARATUS AND METHOD THEREOF

(71) Applicants: HYUNDAI MOTOR COMPANY, Seoul (KR); Kia Corporation, Seoul (KR)

(72) Inventor: Byung Choon YUN, Hwaseong-si (KR)

(21) Appl. No.: 18/830,350

(22) Filed: Sep. 10, 2024

(30) Foreign Application Priority Data
Apr. 19, 2024 (KR) 10-2024-0052918

(51) Int. Cl. B60W 50/04; B60W 50/02; H04W 4/44

(52) U.S. Cl. CPC B60W 50/045; B60W 50/0205; H04W 4/44; B60W 2556/45; B60W 2756/10

(57) ABSTRACT

A vehicle control apparatus includes a memory and a processor. The processor receives first identification information of a vehicle from a vehicle identification number (VIN) management control unit for managing identification information of the vehicle, compares second identification information of the vehicle with the first identification information, based on that the second identification information is identified in the memory, transmits the first identification information to an external server to request configuration information of a plurality of control units associated with the vehicle, based on that the first identification information and the second identification information are different from each other, and monitors the plurality of control units, based on receiving the configuration information from the external server.

### CROSS-REFERENCE TO RELATED APPLICATION

This application claims the benefit of priority to Korean Patent Application No. 10-2024-0052918, filed in the Korean Intellectual Property Office on Apr. 19, 2024, the entire contents of which are incorporated herein by reference.

### TECHNICAL FIELD

The present disclosure relates to a vehicle control apparatus and a method thereof, and more particularly, relates to technologies for monitoring a control unit.

### BACKGROUND

If information about a control unit configured for the first time is permanently maintained, it becomes unusable when the control unit needs to be corrected due to changes in a vehicle assembly or after service (A/S) environment. A vehicle control apparatus may use control unit information to determine a message transmission state of a control unit and/or a state in which the control unit is mounted. Therefore, if the control unit information is not updated, incorrect errors may be detected, and unnecessary fault codes may be recorded. Consequently, there is a need for a method to update vehicle control unit information via a linkage to a remote server based on vehicle identification number (VIN) information, thereby preventing the recording of unnecessary data.

### SUMMARY

The present disclosure is directed to a vehicle control apparatus for monitoring a control unit and a method thereof.

The present disclosure is also directed to a vehicle control apparatus for updating configuration information associated with a control unit and a method thereof.

The present disclosure is also directed to a vehicle control apparatus for establishing a communication link with an external server to update configuration information and a method thereof.

According to an aspect of the present disclosure, a vehicle control apparatus may include a memory and a processor. The processor may be configured to receive first identification information of a vehicle from a vehicle identification number (VIN) management control unit for managing identification information of the vehicle, compare second identification information of the vehicle with the first identification information, based on that the second identification information is identified in the memory, transmit the first identification information to an external server to request configuration information of a plurality of control units associated with the vehicle, based on that the first identification information and the second identification information are different from each other, and monitor the plurality of control units, based on receiving the configuration information from the external server.

In some implementations, the processor may be configured to determine a state of at least one control unit among the plurality of control units as an abnormal state, if not identifying a message associated with the at least one control unit, while monitoring the plurality of control units.

In some implementations, the processor may be configured to output a fault code for the at least one control unit determined as being in the abnormal state.

In some implementations, the processor may be configured to store the first identification information in the memory, based on that the second identification information of the vehicle is not identified in the memory, and transmit the first identification information to the external server.

In some implementations, the processor may be configured to check whether the configuration information associated with the plurality of control units is identified, based on that the first identification information and the second identification information are the same as each other, and transmit the first identification information to the external server to request the configuration information of the plurality of control units associated with the vehicle, if the configuration information is not identified.

In some implementations, the processor may be configured to receive the first identification information of the vehicle, based on that the vehicle control apparatus is mounted on the vehicle.

In some implementations, the processor may be configured to request the identification information of the vehicle from the VIN management control unit, based on identifying that the vehicle is ignition on, and receive the first identification information of the vehicle from the VIN management control unit in response to the request.

In some implementations, the processor may be configured to receive the first identification information of the vehicle, if a voltage associated with the vehicle is included within a specified voltage range.

In some implementations, the processor may be configured to check whether the voltage associated with the vehicle is included within the specified voltage range, after a specified time elapses from a time point when it is identified that the vehicle is ignition on.

In some implementations, the processor may be configured to monitor the plurality of control units, using the configuration information, if the voltage associated with the vehicle is included within the specified voltage range, and fail to monitor the plurality of control units, if the voltage associated with the vehicle is not included within the specified voltage range.

According to another aspect of the present disclosure, a vehicle control method may include receiving first identification information of a vehicle from a vehicle identification number (VIN) management control unit for managing identification information of the vehicle, comparing second identification information of the vehicle with the first identification information, based on that the second identification information is identified in a memory, transmitting the first identification information to an external server to request configuration information of a plurality of control units associated with the vehicle, based on that the first identification information and the second identification information are different from each other, and monitoring the plurality of control units, based on receiving the configuration information from the external server.

In some implementations, the monitoring of the plurality of control units may include determining a state of at least one control unit among the plurality of control units as an abnormal, if not identifying a message associated with the at least one control unit, while monitoring the plurality of control units.

In some implementations, the monitoring of the plurality of control units may further include outputting a fault code for the at least one control unit determined as being in the abnormal state.

In some implementations, the receiving of the first identification information of the vehicle may include storing the first identification information in the memory, based on that the second identification information of the vehicle is not identified in the memory, and transmitting the first identification information to the external server.

In some implementations, the requesting of the configuration information of the plurality of control units associated with the vehicle may include checking whether the configuration information associated with the plurality of control units is identified, based on that the first identification information and the second identification information are the same as each other, and transmitting the first identification information to the external server to request the configuration information of the plurality of control units associated with the vehicle, if the configuration information is not identified.

In some implementations, the receiving of the first identification information may include receiving the first identification information of the vehicle, based on that a vehicle control apparatus is mounted on the vehicle.

In some implementations, the receiving of the first identification information may include requesting the identification information of the vehicle from the VIN management control unit operating, based on identifying that the vehicle is ignition on, and receiving the first identification information of the vehicle from the VIN management control unit in response to the request.

In some implementations, the receiving of the first identification information may include receiving the first identification information of the vehicle, if a voltage associated with the vehicle is included within a specified voltage range.

In some implementations, the receiving of the first identification information may further include checking whether the voltage associated with the vehicle is included within the specified voltage, after a specified time elapses from a time point when it is identified that the vehicle is ignition on.

In some implementations, the monitoring of the plurality of control units may include monitoring the plurality of control units, using the configuration information, if the voltage associated with the vehicle is included within the specified voltage range, and failing to monitor the plurality of control units, if the voltage associated with the vehicle is not included within the specified voltage range.

### BRIEF DESCRIPTION OF THE DRAWINGS

FIG. 1 is a diagram illustrating an example of a block diagram associated with a vehicle control apparatus.

FIG. 2 is a diagram illustrating an example of a flowchart indicating an operation of updating configuration information in a vehicle control apparatus.

FIGS. 3A and 3B are diagram illustrating an example of an environment for updating configuration information in a vehicle control apparatus.

FIG. 4 is a flowchart for describing an example of a vehicle control method.

FIG. 5 is a diagram illustrating an example of a computing system associated with a vehicle control apparatus or a vehicle control method.

### DETAILED DESCRIPTION

Various implementations of the present disclosure may be realized as software (e.g., a program) including one or more instructions stored in a storage medium (e.g., an internal memory or an external memory) readable by a machine (e.g., a vehicle control apparatus 100). For example, a processor (e.g., a processor 110) of the device (e.g., the vehicle control apparatus 100) may invoke at least one of the stored one or more instructions from the storage medium and may execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semi-permanently stored in the storage medium and where data is temporarily stored in the storage medium.

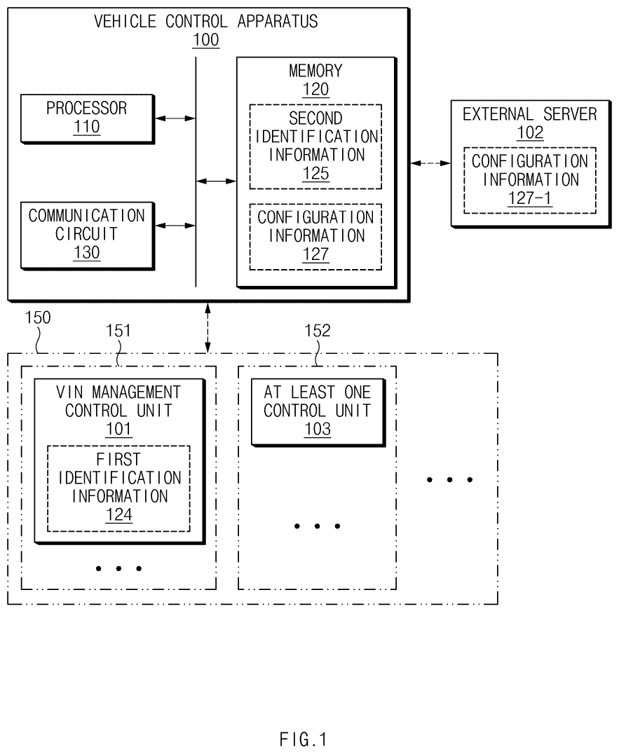

Hereinafter, the present disclosure will be described in detail with reference to FIGS. 1 to 5.

FIG. 1 illustrates an example of a block diagram associated with a vehicle control apparatus.

Referring to FIG. 1, a vehicle control apparatus 100 may be implemented inside or outside a vehicle, and some of components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include other components.

The vehicle control apparatus 100 may include at least one of a processor 110, a memory 120, or a communication circuit 130. The processor 110, the memory 120, and the communication circuit 130 may be electronically or operably coupled with each other by an electronical component including a communication bus. Hereinafter, that pieces of hardware are operably coupled with each other may mean that a direct connection or an indirect connection between the pieces of hardware is established in a wired or wireless manner, such that second hardware is controlled by first hardware among the pieces of hardware. They are illustrated based on the different blocks, but an implementation is not limited thereto. Some of the pieces of hardware of FIG. 1 (e.g., at least some of the processor 110, the memory 120, and the communication circuit 130) may be included in a single integrated circuit such as a system on a chip (SoC). The vehicle control apparatus 100 may control the vehicle, using a plurality of control units 150 connected with the vehicle control apparatus 100.

The processor 110 of the vehicle control apparatus 100 may include hardware for processing data based on one or more instructions. The hardware for processing the data may include, for example, an arithmetic and logic unit (ALU), a floating point unit (FPU), a field programmable gate array (FPGA), a central processing unit (CPU), a micro controlling unit (MCU), and/or an application processor (AP). The number of the processors 110 may be one or more in number. For example, the processor 110 may have a structure of a multi-core processor such as a dual core, a quad core, or a hexa core. Operations below may be performed by the processor 110.

The memory 120 of the vehicle control apparatus 100 may include a hardware component for storing data and/or an instruction input and/or output from the processor 110. The memory 120 may include, for example, a volatile memory, such as a random-access memory (RAM), and/or a non-volatile memory, such as a read-only memory (ROM). The volatile memory may include at least one of, for example, a dynamic RAM (DRAM), a static RAM (SRAM), a cache RAM, or a pseudo SRAM (PSRAM). The non-volatile memory may include at least one of, for example, a programmable ROM (PROM), an erasable PROM (EPROM), an electrically erasable PROM (EEPROM), a flash memory, a hard disk, a compact disc, a solid state drive (and SSD), or an embedded multi-media card (eMMC).

The communication circuit 130 of the vehicle control apparatus 100 may include hardware for supporting transmission and/or reception of an electrical signal between the vehicle control apparatus 100 and an external electronic device (e.g., a server and/or an external vehicle control apparatus different from the vehicle control apparatus 100). For example, the communication circuit 130 may include at least one of a modem, an antenna, or an optic/electronic (O/E) converter. The communication circuit 130 may support transmission and or reception of an electrical signal based on various types of protocols such as an Ethernet for vehicle, a controller area network (CAN), a local interconnect network (LIN), FlexRay, a local area network (LAN), a wide area network (WAN), wireless fidelity (Wi-Fi), Bluetooth, Bluetooth low energy (BLE), ZigBee, long term evolution (LTE), a thread, a matter, and 5th generation new radio (5G NR). However, it is not limited thereto.

In some implementations, the plurality of control units 150 may control driving of at least a part of the vehicle including the vehicle control apparatus 100. For example, the plurality of control units 150 may be referred to as electronic control units in terms of managing electronic devices in the vehicle. The electronic control unit may include an engine control unit, a transmission control unit (TCU), and/or electronic stability control (ESC), depending on a type of an electronic device controllable by the electronic control unit. However, it is not limited thereto.

For example, the plurality of control units 150 may be grouped according to the purpose of controlling at least one function of the vehicle. For example, the group of the plurality of control units 150 may be referred to as a domain (or a network), in terms of being grouped according to at least one function. The domain group may include a chassis domain, an autonomous driving domain, and/or an aftermarket domain. However, it is not limited thereto.

For example, a first domain 151 may include a vehicle identification number (VIN) management control unit 101. The VIN management control unit 101 may include a control unit for managing identification information of the vehicle. The VIN management control unit 101 may include first identification information 124 of the vehicle. The first identification information 124 may indicate a unique serial number assigned to the vehicle. For example, a second domain 152 may include at least one control unit 103. The at least one control unit 103 may include, for example, a control unit which causes a malfunction. However, it is not limited thereto.

One or more instructions indicating calculation and/or an operation to be performed for data by the processor 110 may be stored in the memory 120 of the vehicle control apparatus 100. A set of the one or more instructions may be referred to as firmware, an operating system, a process, a routine, a sub-routine, and/or an application. For example, if a set of a plurality of instructions distributed in the form of an operating system, firmware, a driver, and/or an application is executed, the vehicle control apparatus 100 and/or the processor 110 may perform at least one of operations of FIGS. 6 and 7.

Hereinafter, that software in the form of an operating system, firmware, a driver, and/or an application is installed in the vehicle control apparatus 100 may mean that one or more instructions provided in the form of software are stored in the memory 120 of the vehicle control apparatus 100, which may mean that one or more applications are stored in a format executable by the processor 110 of the vehicle control apparatus 100 (e.g., as a file with an extension specified by an operating system of the vehicle control apparatus 100).

For example, the memory 120 of the vehicle control apparatus 100 may include second identification information 125. The second identification information 125 may include vehicle identification number (VIN) information of the vehicle. If the vehicle control apparatus 100 is mounted on the vehicle, it may obtain the second identification information 125. However, it is not limited thereto. The second identification information 125 may be referred to as past identification information, in terms of being obtained before receiving the first identification information 124. The first identification information 124 may be referred to as current identification information, in terms of being obtained after a time point when the second identification information 125 is obtained.

For example, the memory 120 of the vehicle control apparatus 100 may include configuration information 127. The configuration information 127 may include information associated with the plurality of control units 150. For example, the configuration information 127 may include information about types of the plurality of control units 150 and/or a message to be generated between the plurality of control units 150.

For example, the configuration information 127 may include identification information of a message associated with each of the plurality of control units 150, information (e.g., group information, channel information, or domain information) of a control unit which transmits the message, a period for transmitting the message, or information (e.g., group information, channel information, or domain information) of a control unit to receive the message.

For example, the information about the message to be generated between the plurality of control units 150 may include at least one of a type of a protocol corresponding to the message, a position at which message data indicating the type of the protocol will be disposed in the message (or a position assigned to the message data), or consistency between control units associated with the message, or any combination thereof.

In some implementations, the vehicle control apparatus 100 may establish a communication link with an external server 102, using Ethernet communication. Referring to FIG. 1, it is shown that the vehicle control apparatus 100 and the external server 102 are directly connected with each other. However, the vehicle control apparatus 100 and the external server 102 are indirectly connected with each other, via a control unit (e.g., a server communication control unit). The external server 102 may include a server for managing information (e.g., configuration information 127-1) associated with control units in the vehicle according to the identification information (e.g., the VIN) of the vehicle.

The vehicle control apparatus 100 may identify that the vehicle is ignition on. After a specified time (e.g., about 2 seconds) elapses from the time point when the vehicle is ignition on, the vehicle control apparatus 100 may request the configuration information 127-1 from the external server 102. For example, if the voltage of the vehicle (e.g., a battery voltage or a voltage associated with the engine) is included within a specified range, the vehicle control apparatus 100 may request the configuration information 127-1 from the external server 102. For example, the configuration information 127-1 may be mapped to the identification information of the vehicle. The configuration information 127-1 may include the configuration information 127.

For example, the vehicle control apparatus 100 may update the configuration information 127 in the memory 120, based on receiving the configuration information 127-1 from the external server 102. However, it is not limited thereto.

After a specified time (e.g., about 5 seconds) elapses from the time point when the vehicle is ignition on, the vehicle control apparatus 100 may monitor states of the plurality of control units 150 in the vehicle, using the configuration information 127.

For example, the vehicle control apparatus 100 may be referred to as a network monitoring control unit, in terms of monitoring states of the plurality of control units 150.

For example, the vehicle control apparatus 100 may identify a fault code (e.g., a diagnostic trouble code (DTC)) for the at least one control unit 103 diagnosed as being in an abnormal state, while monitoring the states of the plurality of control units 150.

In some implementations, the vehicle control apparatus 100 may output the fault code. For example, the vehicle control apparatus 100 may transmit the fault code to an external electronic device (e.g., a diagnostic device).

As described above, the vehicle control apparatus 100 may monitor a control unit (e.g., the plurality of control units 150) connected with a network (or a domain) managed by the vehicle control apparatus 100, in a driving state (e.g., IGN ON) of the vehicle. The state of the control unit may be defined based on whether the control unit generates a message at a certain period and/or is normally mounted.

The vehicle control apparatus 100 may obtain identification information (e.g., the first identification information 124) of the vehicle from the VIN management control unit 101 to monitor the state of the control unit. The vehicle control apparatus 100 may transmit the identification information of the vehicle to the external server 102 to update the configuration information 127 indicating a configuration of the control unit included in the vehicle. The vehicle control apparatus 100 may identify (or define) a control unit to be monitored, using the configuration information 127. The vehicle control apparatus 100 may update the configuration information 127, thus more accurately determining a fault state (or an abnormal state) of the control unit.

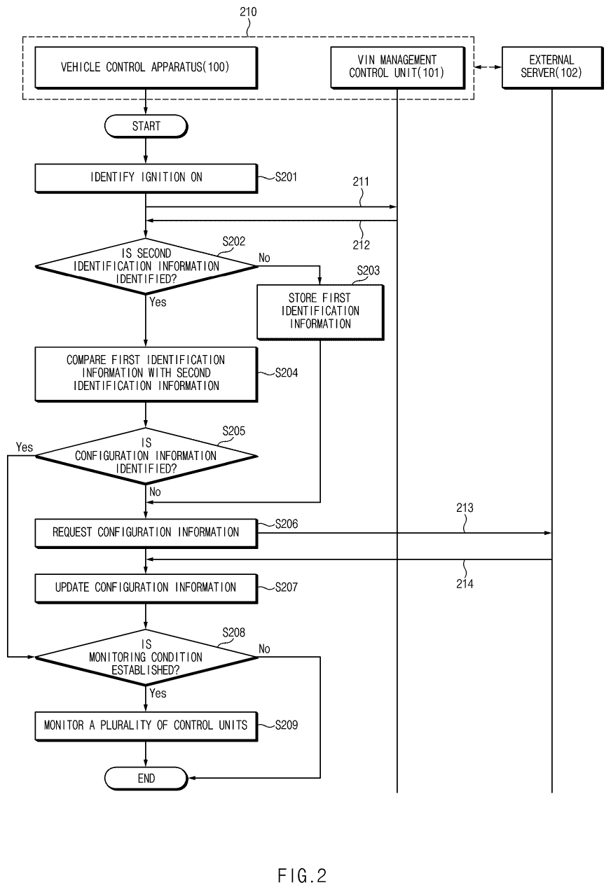

FIG. 2 illustrates an example of a flowchart indicating an operation of updating configuration information in a vehicle control apparatus. Hereinafter, it is assumed that a vehicle control apparatus 100 of FIG. 1 performs a process of FIG. 2. Furthermore, in a description of FIG. 2, an operation described as being performed by a vehicle control apparatus may be understood as being controlled by a processor 110 of a vehicle control apparatus 100. The respective operations of FIG. 2 may be sequentially performed, but are not necessarily sequentially performed. For example, an order of the respective operations may be changed, and at least two operations may be performed in parallel.

Referring to FIG. 2, the vehicle control apparatus 100 and a VIN management control unit 101 may be included in a vehicle 210.

Referring to FIG. 2, in S201, the vehicle control apparatus 100 may identify that ignition of the vehicle 210 is on. For example, the vehicle control apparatus 100 may identify that the vehicle is turned on (e.g., key-on).

In some implementations, the vehicle control apparatus 100 may request identification information of the vehicle 210 to the VIN management control unit 101, based on identifying that the vehicle 210 is ignition on.

For example, the vehicle control apparatus 100 may transmit a signal 211 for requesting the identification information of the vehicle 210 to the VIN management control unit 101.

In some implementations, the VIN management control unit 101 may transmit a signal 212 indicating first identification information (e.g., first identification information 124 of FIG. 1) of the vehicle 210 to the vehicle control apparatus 100, in response to the signal 211.

For example, the vehicle control apparatus 100 may receive the first identification information of the vehicle 210 from the VIN management control unit 101 in response to the request.

For example, the vehicle control apparatus 100 may receive the first identification information of the vehicle 210, based on the vehicle control apparatus 100 being mounted (or initially mounted) on the vehicle 210.

In some implementations, if a voltage associated with the vehicle 210 (e.g., a battery voltage or a voltage associated with the engine) is within a specified voltage range (e.g., between 6 V and 16 V), the vehicle control apparatus 100 may receive the first identification information of the vehicle 210. For example, after a specified time (e.g., about 2 seconds) elapses from the time point when the ignition of the vehicle 210 is on, the vehicle control apparatus 100 may determine whether the voltage associated with the vehicle 210 is within the specified voltage range.

For example, if the voltage associated with the vehicle 210 is out of the specified voltage range, the vehicle control apparatus 100 may fail to request the identification information of the vehicle 210 to the VIN management control unit 101.

For example, if the voltage associated with the vehicle 210 is within the specified voltage range, the vehicle control apparatus 100 may transmit the signal 211 to the VIN management control unit 101. However, it is not limited thereto.

In S202, the vehicle control apparatus 100 may determine whether it is able to identify second identification information, based on the first identification information of the vehicle 210 being received from the VIN management control unit 101 configured to manage the identification information of the vehicle 210.

In S203, the vehicle control apparatus 100 may store the first identification information in a memory 120, based on that the second identification information of the vehicle 210 is not identified in the memory 120 (S202—No). For example, after performing S203, in S206, the vehicle control apparatus 100 may transmit the first identification information to an external server 102.

In S204, the vehicle control apparatus 100 may compare the second identification information with the first identification information, based on that the second identification information of the vehicle is identified in the memory 120 (S202—Yes).

For example, in S206, the vehicle control apparatus 100 may transmit the first identification information to the external server 102, based on that the first identification information and the second identification information are different from each other, to thereby request configuration information of a plurality of control units associated with the vehicle 210. For example, if the first identification information and the second identification information are different from each other, the vehicle control apparatus 100 may bypass an operation (S205) of identifying the configuration information to perform S206.

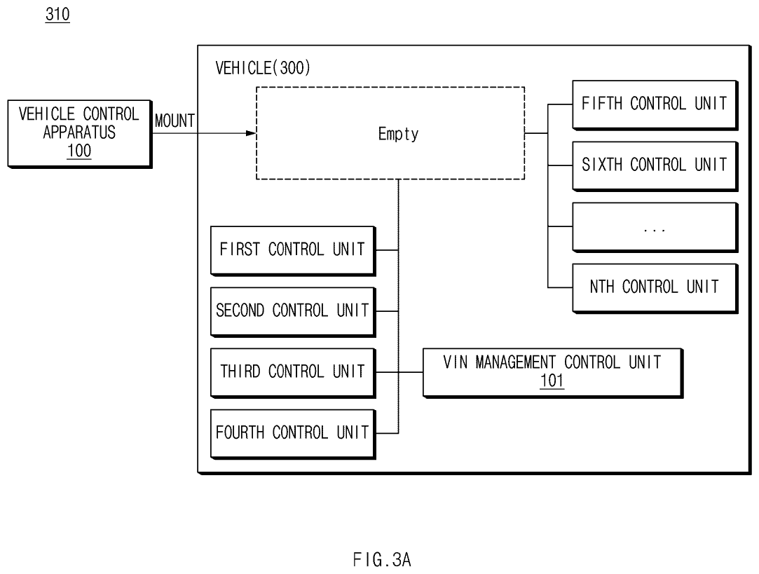

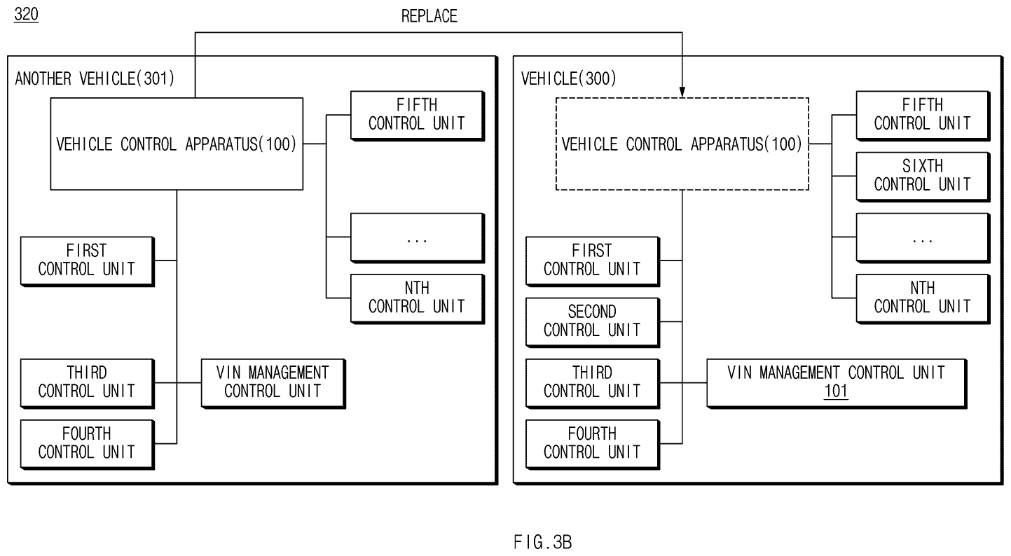

For example, if the first identification information and the second identification information are different from each other, the vehicle control apparatus 100 may update the second identification information by using the first identification information. A description of the case in which the first identification information and the second identification information are different from each other will be described below with reference to FIGS. 3A and 3B.

In some implementations, in S205, the vehicle control apparatus 100 may determine whether the configuration information associated with the plurality of control units is identified, based on that the first identification information and the second identification information are identical to each other. For example, the case in which the first identification information and the second identification information are the same as each other may refer to a case in which the first identification information and the second identification information include the same information.

If the configuration information is identified in the memory 120 (S205—Yes), the vehicle control apparatus 100 may perform S208.

If the configuration information is not identified (S205—No), in S206, the vehicle control apparatus 100 may request the configuration information from the external server 102. For example, the vehicle control apparatus 100 may transmit the first identification information to the external server 102 to thereby request the configuration information of the plurality of control units associated with the vehicle 210.

For example, the vehicle control apparatus 100 may transmit a signal 213 indicating the first identification information to the external server 102 to thereby request the configuration information of the plurality of control units associated with the vehicle 210.

For example, the external server 102 may receive the signal 213 and transmit, to the vehicle control apparatus 100, a signal 214 indicating configuration information (e.g., configuration information 127-1 of FIG. 1) corresponding to the first identification information.

In S207, the vehicle control apparatus 100 may update the configuration information, based on the signal 214 being received.

In S208, the vehicle control apparatus 100 may determine whether a condition for monitoring states of the plurality of control units is established. For example, the vehicle control apparatus 100 may determine whether to monitor states of the plurality of control units, using the updated configuration information.

For example, the condition for monitoring the states of the plurality of control units may indicate a state in which the vehicle control apparatus 100 monitors the states of the plurality of control units.

For example, the condition for monitoring the states of the plurality of control units may include a case in which a specified time (e.g., about 5 seconds) elapses from a time point when the vehicle 210 is ignition on. For example, the condition for monitoring the states of the plurality of control units may include a case in which the voltage associated with the vehicle 210 is included within the specified voltage range. For example, the condition for monitoring the states of the plurality of control units may include a case in which the configuration information associated with the plurality of control units is identified.

If the monitoring condition is established (S208—Yes), in S209, the vehicle control apparatus 100 may monitor the plurality of control units.

For example, if identifying an error in the vehicle 210, the vehicle control apparatus 100 may fail to monitor the plurality of control units. For example, if the voltage associated with the vehicle 210 is not included in the specified voltage range, the vehicle control apparatus 100 may fail to monitor the plurality of control units. If the voltage associated with the vehicle 210 is not included in the specified voltage range, the vehicle control apparatus 100 may fail to monitor the plurality of control units to internally prevent a malfunction of the vehicle control apparatus 100.

For example, if the voltage associated with the vehicle 210 is included in the specified voltage range, the vehicle control apparatus 100 may monitor the plurality of control units, using the configuration information.

For example, the vehicle control apparatus 100 may monitor the plurality of control units, based on receiving the configuration information from the external server 102.

For example, if not identifying a message associated with at least one control unit among the plurality of control units, while monitoring the plurality of control units, the vehicle control apparatus 100 may determine a state of the at least one control unit as an abnormal state.

For example, the vehicle control apparatus 100 may output a fault code for the at least one control unit determined as being in the abnormal state.

For example, the plurality of control units may perform cooperative control to generate a message. For example, if not identifying the message associated with the at least one control unit among the plurality of control units, the vehicle control apparatus 100 may determine the state of the at least one control unit as a state in which the at least one controller does not normally perform a function. However, it is not limited thereto.

FIGS. 3A and 3B illustrate an example of an environment for updating configuration information in a vehicle control apparatus. A vehicle control apparatus 100 of FIGS. 3A and 3B may be referred to a vehicle control apparatus 100 of FIG. 1.

Referring to FIG. 3A, an example 310 in which the vehicle control apparatus 100 is mounted on a vehicle 300 for the first time is illustrated. The vehicle 300 may be referred to a vehicle 210 of 2. For example, the vehicle control apparatus 100 may be mounted on the vehicle 300 for the first time. The vehicle 300 may include a VIN management control unit 101 and first to Nth control units. The vehicle control apparatus 100 may receive first identification information of the vehicle 300 from the VIN management control unit 101, based on being mounted on the vehicle 300. However, it is not limited thereto.

For example, the example 310 may include a case in which the vehicle control apparatus 100 should be replaced in a maintenance situation of the vehicle 300. For example, the vehicle control apparatus 100 may obtain identification information and configuration information, based on that the vehicle 300 is ignition on, after being mounted on the vehicle 300.

For example, if the vehicle control apparatus 100 is mounted on the vehicle 300 for the first time, it may fail to include identification information (e.g., second identification information 125 of FIG. 1) of the vehicle 300. The vehicle control apparatus 100 may receive the identification information of the vehicle 300 from the VIN management control unit 101 to store the received identification information in a memory (e.g., a non-volatile memory).

In some implementations, the vehicle control apparatus 100 may obtain the identification information and the configuration information, based on that the vehicle 300 is ignition on, after being mounted in the vehicle 300 not to consider an option and control unit configuration information of the vehicle 300, thus not generating an additional maintenance requirement for a user to reinforce user convenience.

Referring to FIG. 3B, an example 320 may indicate a case in which the vehicle control apparatus 100 is replaced from another vehicle 301 independent of the vehicle 300 to the vehicle 300.

For example, the vehicle control apparatus 100 may first be mounted on the other vehicle 301 and may then be mounted the vehicle 300. The identification information of the vehicle 300 may be different from identification information of the other vehicle 301.

For example, configuration information of control units included in the other vehicle 301 may be different from configuration information of control units included in the vehicle 300.

For example, after the vehicle control apparatus 100 is mounted on the vehicle 300, it may identify that the vehicle 300 is ignition on. The vehicle control apparatus 100 may perform at least one of operations of FIG. 2, based on identifying that the vehicle 300 is ignition on, thus obtaining the identification information and/or configuration information of the vehicle 300. The vehicle control apparatus 100 may monitor a plurality of control units in the vehicle 300, based on obtaining the identification information and/or the configuration information.

In some implementations, if a wrong vehicle control apparatus is mounted on the vehicle 300 due to or a user error in a vehicle assembly line and after service (A/S) environment, the vehicle control apparatus 100 may obtain the identification information and/or the configuration information of the vehicle 300, without a series of behaviors of the user for initializing control unit information, thus reinforcing user convenience.

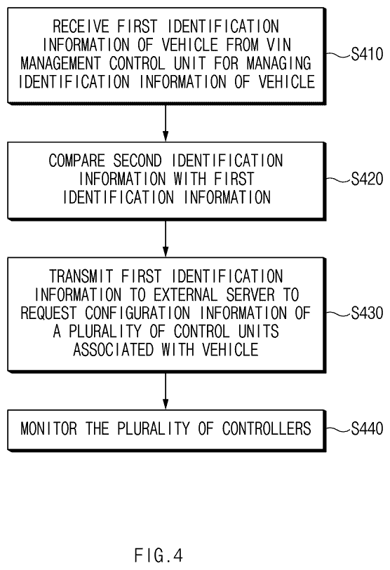

Hereinafter, a description will be given in detail of a vehicle control method according to another implementation of the present disclosure with reference to FIG. 4. FIG. 4 is a flowchart for describing a vehicle control method. At least one of operations of FIG. 4 may be associated with at least one of operations of FIG. 2.

Hereinafter, it is assumed that a vehicle control apparatus 100 of FIG. 1 performs a process of FIG. 4. Furthermore, in a description of FIG. 4, an operation described as being performed by a vehicle control apparatus may be understood as being controlled by a processor 110 of a vehicle control apparatus 100. The respective operations of FIG. 4 may be sequentially performed, but are not necessarily sequentially performed. For example, an order of the respective operations may be changed, and at least two operations may be performed in parallel.

Referring to FIG. 4, in S410, the vehicle control method may include receiving first identification information of a vehicle from a VIN management control unit configured to manage identification information of the vehicle. For example, the vehicle control method may include receiving the first identification information based on identifying that ignition of the vehicle is on.

Referring to FIG. 4, in S420, the vehicle control method may include comparing second identification information with the first identification information.

For example, the vehicle control apparatus may fail to identify the second identification information in an example 310 of FIG. 3A. In this case, the vehicle control method may include storing the first identification information in a memory.

For example, in an example 320 of FIG. 3B, the vehicle control method may include comparing the second identification information different from the first identification information with the first identification information. For example, the vehicle control method may include storing the first identification information in the memory, if the first identification information and the second identification information are different from each other. For example, the vehicle control method may include identifying the first identification information as more up-to-date information than the second identification information. Because the first identification information is more up-to-date information than the second identification information, the vehicle control apparatus may store the first identification information in the memory.

Referring to FIG. 4, in S430, the vehicle control method may include transmitting the first identification information to an external server (e.g., an external server 102 of FIG. 1) to request configuration information of a plurality of control units associated with the vehicle.

Referring to FIG. 4, in S440, the vehicle control method may include monitoring the plurality of controllers.

For example, while monitoring the plurality of control units, the vehicle control apparatus may fail to identify a message associated with at least one controller among the plurality of control units. By way of further example, the vehicle control apparatus may fail to identify the message associated with the at least one controller during a specified time. The vehicle control apparatus may check the number of times that the message associated with the at least one control unit is not identified. If the number of times that the message associated with the at least one control unit is not identified is greater than a specified number, the vehicle control apparatus may determine a state of the at least one control unit as an abnormal state. The vehicle control apparatus may output a fault code indicating the state of the at least one control unit. However, it is not limited thereto.

As described above, the vehicle control apparatus and/or the vehicle control method may monitor a network controller (e.g., a plurality of control units 150 of FIG. 1) of the vehicle based on updated vehicle control unit configuration information (e.g., configuration information 127-1 of FIG. 1) using a vehicle management remote server (e.g., an external server 102 of FIG. 1). As described above, the vehicle control apparatus and/or the vehicle control method may obtain accurate configuration information of control units in the vehicle, without addition manipulation after the vehicle is assembled. As described above, the vehicle control apparatus and/or the vehicle control method may prevent a function malfunction of the vehicle control apparatus due to a work error of the user, thus improving the quality of the vehicle.

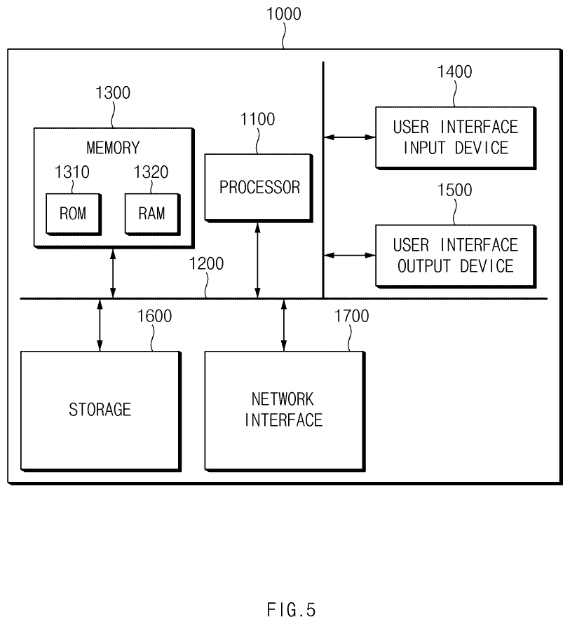

FIG. 5 illustrates a computing system associated with a vehicle control apparatus or a vehicle control method.

Referring to FIG. 5, The computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600.

The memory 1300 and the storage 1600 may include various types of volatile or non-volatile storage media. For example, the memory 1300 may include a ROM (Read Only Memory) 1310 and a RAM (Random Access Memory) 1320. The processor 1100 may correspond to the processor 110 of FIG. 1.

Thus, the operations of the method or the algorithm described in connection with the implementations disclosed herein may be implemented directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The present technology may monitor a control unit.

The present technology may update configuration information associated with the control unit. Furthermore, the present technology may establish a communication link with an external server to update the configuration information.

What is claimed is:

1. A vehicle control apparatus, comprising:
a memory storing instructions; and
a processor configured to execute the instructions to perform operations comprising:
receiving, from a vehicle identification number (VIN) management control unit configured to manage identification information of a vehicle, a first identification information of the vehicle;
comparing, based on a second identification information being identified in the memory, the second identification information the vehicle with the first identification information;
transmitting, based on the first identification information and the second identification information being different from each other, the first identification information to an external server to request configuration information of a plurality of control units associated with the vehicle; and
monitoring, based on the configuration information being received from the external server, the plurality of control units.

2. The vehicle control apparatus of claim 1, wherein the operations further comprise:
determining, based on a message associated with at least one control unit among the plurality of control units not being identified while the plurality of control units are monitored, a state of the at least one control as an abnormal state.

3. The vehicle control apparatus of claim 2, wherein the operations further comprise:
outputting a fault code for the at least one control unit determined as being in the abnormal state.

4. The vehicle control apparatus of claim 1, wherein the operations further comprise:
storing, based on the second identification information of the vehicle not being identified in the memory, the first identification information in the memory; and
transmitting the first identification information to the external server.

5. The vehicle control apparatus of claim 1, wherein the operations further comprise:
determining, based on the first identification information and the second identification information being identical to each other, whether the configuration information associated with the plurality of control units is identified; and
transmitting, based on the configuration information not being identified, the first identification information to the external server to request the configuration information of the plurality of control units associated with the vehicle.

6. The vehicle control apparatus of claim 1, wherein the operations further comprise:
receiving, based on the vehicle control apparatus being mounted on the vehicle, the first identification information of the vehicle.

7. The vehicle control apparatus of claim 1, wherein the operations further comprise:
requesting, based on identifying that ignition of the vehicle is on, the identification information of the vehicle from the VIN management control unit; and
receiving, in response request, the first identification information of the vehicle from the VIN management control unit.

8. The vehicle control apparatus of claim 1, wherein the operations further comprise:
receiving, based on a voltage associated with the vehicle being within a specified voltage range, the first identification information of the vehicle.

9. The vehicle control apparatus of claim 8, wherein the operations further comprise:
determining whether the voltage associated with the vehicle is within the specified voltage range, after a specified time elapses from a time point when ignition of the vehicle is identified as on.

10. The vehicle control apparatus of claim 8, wherein the operations further comprise:
monitoring, based on the voltage associated with the vehicle being within the specified voltage range, the plurality of control units using the configuration information, and
wherein the processor fails to monitor the plurality of control units based on the voltage associated with the vehicle not being included within the specified voltage range.

11. A vehicle control method, comprising:
receiving, from a vehicle identification number (VIN) management control unit configured to manage identification information of a vehicle, a first identification information of the vehicle;
comparing, based on a second identification information being identified in a memory, the second identification information of the vehicle with the first identification information;
transmitting, based on the first identification information and the second identification information being different from each other, the first identification information to an external server to request configuration information of a plurality of control units associated with the vehicle; and
monitoring, based on the configuration information being received from the external server, the plurality of control units.

12. The vehicle control method of claim 11, wherein monitoring the plurality of control units includes:
Determining, based on a message associated with at least one control unit not being identified while the plurality of control units are monitored, a state of the at least one control unit among the plurality of control units as an abnormal state.

13. The vehicle control method of claim 12, wherein monitoring the plurality of control units further includes:
outputting a fault code for the at least one control unit determined as being in the abnormal state.

14. The vehicle control method of claim 11, wherein receiving the first identification information of the vehicle includes:
storing, based on the second identification information of the vehicle not being identified in the memory, the first identification information in the memory; and
transmitting the first identification information to the external server.

15. The vehicle control method of claim 11, wherein requesting the configuration information of the plurality of control units associated with the vehicle includes:
determining, based on the first identification information and the second identification information being identical to each other, whether the configuration information associated with the plurality of control units is identified; and
transmitting, based on the configuration information not being identified, the first identification information to the external server to request the configuration information of the plurality of control units associated with the vehicle.

16. The vehicle control method of claim 11, wherein receiving the first identification information includes:
receiving, based on a vehicle control apparatus being mounted on the vehicle, the first identification information of the vehicle.

17. The vehicle control method of claim 11, wherein receiving the first identification information includes:
requesting, based on identifying that ignition of the vehicle is on, the identification information of the vehicle from the VIN management control unit operating; and
receiving, in response to the request, the first identification information of the vehicle from the VIN management control unit.

18. The vehicle control method of claim 11, wherein receiving the first identification information includes:
receiving, based on a voltage associated with the vehicle being within a specified voltage range, the first identification information of the vehicle.

19. The vehicle control method of claim 18, wherein receiving the first identification information further includes:
determining whether the voltage associated with the vehicle is within the specified voltage range, after a specified time elapses from a time point when ignition of the vehicle is identified as on.

20. The vehicle control method of claim 18, wherein monitoring the plurality of control units includes:
monitoring, based on the voltage associated with the vehicle being within the specified voltage range, the plurality of control units using the configuration information, and
wherein monitoring the plurality of control units fails based on the voltage associated with the vehicle not being within the specified voltage range.
